(19) United States
(12) Patent Application Publication
(10) Pub. No.: US 2018/0111773 A1
(43) Pub. Date: Apr. 26, 2018

(54) SHEET POSITION CORRECTION DEVICE

(71) Applicant: CANON KABUSHIKI KAISHA, Tokyo (JP)

(72) Inventor: Yuya Yokobori, Kashiwa-shi (JP)

(21) Appl. No.: 15/789,213

(22) Filed: Oct. 20, 2017

(30) Foreign Application Priority Data
Oct. 26, 2016 (JP) 2016-209781

(51) Int. Cl. B65H 9/00; B65H 9/20; B65H 35/00; G03G 15/00

(52) U.S. Cl. CPC B65H 9/002; B65H 9/20; B65H 2801/06; G03G 15/6502; B65H 35/0006

(57) ABSTRACT

A sheet position correction device includes a detection unit, a skew correcting portion, a moving unit, and a control unit. The detection unit is configured to detect inclination of a sheet, and a position of a sheet in a width direction. The skew correcting portion is configured to convey the sheet, and correct skewing of the sheet. The moving unit is configured to move the skew correcting portion in the width direction. The control unit is configured to perform control such that skew correction of the sheet by the skew correcting portion and movement of the skew correcting portion by the moving unit are performed in parallel based on a detection result of the detection unit.

### BACKGROUND OF THE INVENTION

### Field of the Invention

The present invention relates to a sheet position correction device configured to correct position of sheets.

### Description of the Related Art

Hitherto, as shown in Japanese Unexamined Patent Application Publication No. 2014-047023, image forming systems are known in which a finisher unit including a punch unit configured to punch holes to a sheet is connected to a lateral area of image forming apparatuses such as copying machines, printers, facsimiles, or multifunction devices having a plurality of such functions.

In this type of image forming system, at first, skewing of the sheet is corrected by having a leading edge of the sheet abut against a pair of registration rollers in a stopped state to correct the position of the sheet before performing a punching process in the punch unit. Thereafter, the image forming system rotates the pair of registration rollers to convey the sheet, while moving the pair of registration rollers in a width direction orthogonal to a sheet conveyance direction based on position information of the sheet detected by a detection sensor. Thereby, the skewing of the sheet and the position of the sheet in the width direction are corrected.

However, according to the image forming system disclosed in the above-described Japanese Unexamined Patent Application Publication No. 2014-047023, position correction in the width direction of the sheet is performed after completing skew correction of the sheet. Therefore, there was a drawback in that the correction of skewing and position of the sheet in the width direction required much time, and the productivity was deteriorated.

### SUMMARY OF THE INVENTION

According to one aspect of the present invention, a sheet position correction device includes a detection unit configured to detect inclination of a sheet, and a position of a sheet in a width direction orthogonal to a sheet conveyance direction, a skew correcting portion comprising first and second conveyance portions arranged in the width direction, the skew correcting portion being configured to convey the sheet, and correct skewing of the sheet by a difference between a conveyance distance of the sheet by the first conveyance portion and a conveyance distance of the sheet by the second conveyance portion, a moving unit configured to move the skew correcting portion in the width direction, and a control unit configured to perform control such that skew correction of the sheet by the skew correcting portion and movement of the skew correcting portion by the moving unit are performed in parallel based on a detection result of the detection unit.

Further features of the present invention will become apparent from the following description of exemplary embodiments with reference to the attached drawings.

### BRIEF DESCRIPTION OF THE DRAWINGS

FIG. 1 illustrates an entire schematic diagram illustrating an image forming system according to a first embodiment.

FIG. 2 is a schematic diagram of a punching apparatus viewed from a shaft direction of a punch.

FIG. 3 is a control block diagram of a main body control unit and a processing control unit.

FIG. 4 is a flowchart illustrating a position correction process and a punching process.

FIG. 5 is an explanatory view illustrating an amount of deviation of a sheet.

FIG. 6 is an enlarged view of area A of FIG. 5.

FIG. 7 is a flowchart illustrating a position correction process and a punching process according to a second embodiment.

### DESCRIPTION OF THE EMBODIMENTS

### First Embodiment

### Image Forming System

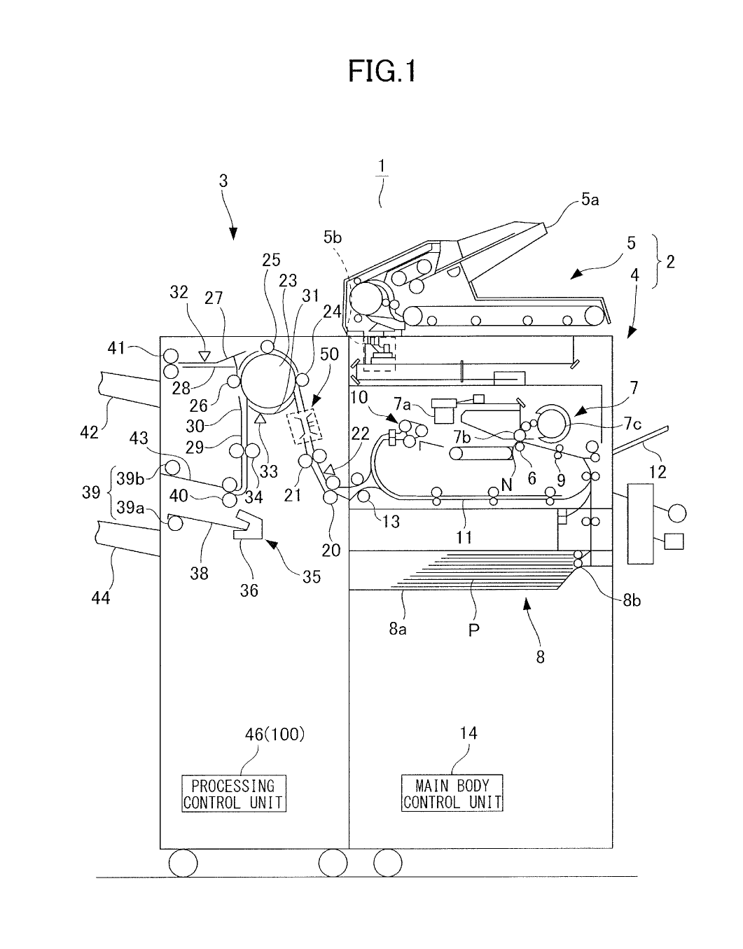

An image forming system 1 according to a first embodiment includes, as illustrated in FIG. 1, a printer 2 which is a laser beam printer adopting an electrophotographic system, a finisher 3 configured to provide various processes to a sheet on which an image has been formed by the printer 2. In the present embodiment, image forming apparatuses such as copying machines, facsimiles and multifunction devices can be adopted instead of the printer. The term sheet refers to paper such as printer paper and envelope, plastic film for overhead projectors (OHT), and other sheet-type recording media such as cloth.

### General Configuration of Printer

The printer 2 includes a printer body 4 configured to form images on a sheet P, and an image reading apparatus 5 configured to read images on a document. The image reading apparatus 5 is arranged above the printer body 4, and the finisher 3 is arranged on a lateral area of the printer body 4. The image reading apparatus 5 is equipped with an ADF (Automatic Document Feeder) 5a capable of feeding documents automatically, and documents conveyed by the ADF 5a are read optically by an optical unit 5b. Image information read by the optical unit 5b is transmitted to the printer body 4. The printer body 4 is equipped with an image forming unit 7 serving as an image forming unit configured to form an image on a sheet P, a sheet feeding unit 8 configured to feed sheets to the image forming unit 7, and a fixing unit 10.

If a signal instructing start of an image forming operation, i.e., print job, is entered to a main body control unit 14 provided on the printer body 4, the image forming unit 7 starts the image forming operation. The image forming unit 7 is equipped with a photosensitive drum 7b, a laser scanner 7a, a charging unit not shown, a developing unit 7c, and a transfer roller 6. The surface of the photosensitive drum 7b is charged uniformly in advance by a charging unit not shown, and an electrostatic latent image is formed on the surface by irradiating laser beams from the laser scanner 7a. The laser scanner 7a oscillates laser beams to the photosensitive drum 7b being rotated, based on image information read by the image reading apparatus 5 or image information transmitted from an outside computer. Then, by supplying toner to the photosensitive drum 7b from the developing unit 7c, the electrostatic latent image on the photosensitive drum 7b is visualized as toner image.

In parallel with the image forming operation, the sheet feeding unit 8 starts a feeding operation of the sheet P. The sheet feeding unit 8 includes a cassette 8a arranged in the printer body 4, a pick roller not shown configured to feed the sheet P, and a separation roller pair 8b. The cassette 8a is inserted to the printer body 4 so that it can be drawn out by an operator. The sheets P stored in the cassette 8a are fed by the pickup roller, and conveyed while being separated one by one by the separation roller pair 8b. The sheet P having been conveyed by the separation roller pair 8b is subjected to skew correction by a registration roller pair 9, and conveyed toward a transfer nip N formed by the photosensitive drum 7b and the transfer roller 6 at a matched timing with the progression of image forming operation by the image forming unit 7.

Transfer bias is applied to the transfer roller 6 at the transfer nip N, by which a toner image formed on the photosensitive drum 7b is transferred to the sheet P, before the sheet is conveyed to the fixing unit 10. The toner image on the sheet P conveyed to the fixing unit 10 is subjected to heat and pressure by a heating roller and a pressure roller, and fixed onto the sheet P.

In the case of simplex printing, the sheet P discharged from the fixing unit 10 is conveyed to the finisher 3 by the sheet discharge roller pair 13. Meanwhile, in the case of duplex printing, the sheet P discharged from the fixing unit 10 is subjected to switch-back and conveyed to a duplex conveyance path 11. Then, the sheet P is passed through the duplex conveyance path 11 and conveyed again to the image forming unit 7, where an image is formed on a rear side thereof. The sheet P having images formed on both sides is conveyed by the sheet discharge roller pair 13 to the finisher 3.

### General Configuration of Finisher

Next, the finisher 3 will be described with reference to a conveyance path of the sheet P. An inlet roller pair 20 is provided on an entrance side of the finisher 3, receiving the sheet P discharged through the sheet discharge roller pair 13 of the printer body 4 by the inlet roller pair 20. The received sheet P is conveyed to the punching apparatus 50 by a conveyance roller pair 21 arranged downstream of the inlet roller pair 20 and the inlet roller pair 20 in the sheet conveyance direction. A sheet detection sensor 22 is arranged between the inlet roller pair 20 and the conveyance roller pair 21, and passing of the sheet P is detected by the sheet detection sensor 22.

Holes are punched to the sheet P detected by the sheet detection sensor 22 on an upstream side in the sheet conveyance direction, that is, trailing edge portion, of the sheet P by the punching apparatus 50. The sheet P to which holes have been punched by the punching apparatus 50 is pressed against a circumference surface of a buffer roller 23 having a relatively large diameter by press rollers 24, 25 and 26. If there is no need to punch holes to the sheet P, the sheet P is conveyed to the buffer roller 23 without being subjected to punching by the punching apparatus 50.

A first switching member 27 configured to selectively switch the conveyance destination of the sheet P between the press roller 26 and a non-sorting path 28 is disposed downstream of the press roller 25 in the sheet conveyance direction. If the sheet P is conveyed by the first switching member 27 to the non-sorting path 28, the passing of the sheet P on the non-sorting path 28 is detected by a sheet detection sensor 32 serving as a sheet detection sensor provided on the non-sorting path 28. Then, the sheet P is discharged through a sheet discharge roller pair 41 provided on a downstream end portion of the non-sorting path 28 in the sheet conveyance direction onto a sample tray 42.

Further, a second switching member 30 configured to selectively switch the conveyance destination of the sheet P between a sorting path 29 and a buffer path 31 for temporarily storing the sheet P is disposed downstream of the press roller 26 in the sheet conveyance direction. The sheet P conveyed by the second switching member 30 to the sorting path 29 is discharged through conveyance roller pairs 34 and 40 to an intermediate processing unit 35. The intermediate processing unit 35 includes an intermediate processing tray 38 on which the sheets are supported, and a staple unit 36. A sheet bundle of the sheets P conveyed by the conveyance roller pair 40 to the intermediate processing unit 35 is supported and aligned on the intermediate processing tray 38. The sheet bundle having been aligned can be stapled by the staple unit 36.

The sheet bundle having been subjected to aligning process or stapling process in the intermediate processing unit 35 is discharged by a sheet discharge roller pair 39 onto a stack tray 44. The sheet discharge roller pair 39 is composed of a lower sheet discharge roller 39a arranged on a downstream end in the sheet conveyance direction of the intermediate processing tray 38, and an upper sheet discharge roller 39b arranged on a downstream end of a swing guide 43 arranged above the intermediate processing tray 38. The swing guide 43 is supported swingably in upper and lower directions, and the upper sheet discharge roller 39b is configured to swing in upper and lower directions by the swinging of the swing guide 43. After the aligning process or the stapling process has been performed, the swing guide 43 swings downward, and the upper sheet discharge roller 39b is pressed by the lower sheet discharge roller 39a. Thereby, the sheet bundle supported on the intermediate processing tray 38 is nipped by the lower sheet discharge roller 39a and the upper sheet discharge roller 39b, and by the rotation of the sheet discharge roller pair 39, the sheet bundle is discharged onto the stack tray 44.

While the sheet processing by the intermediate processing unit 35 and the discharge of sheet bundle to the stack tray 44 are performed, the sheet to be subjected to next sheet processing by the intermediate processing unit is temporarily stored in the buffer roller 23. The buffer roller 23 stops when the sheet P conveyed to the buffer path 31 is detected by a sheet detection sensor 33, and the sheet P is temporarily stored in the buffer path 31.

In a state where the sheet processing by the intermediate processing unit 35 and the discharge of the sheet bundle to the stack tray 44 are not completed, the succeeding sheet P is superposed on the sheet P stored in advance in the buffer path 31 and accumulated. If the sheet processing by the intermediate processing unit 35 and the discharge of the sheet bundle to the stack tray 44 are completed, the buffer roller 23 conveys the plurality of sheets P being stored to the sorting path by the second switching member 30.

### Punching Apparatus

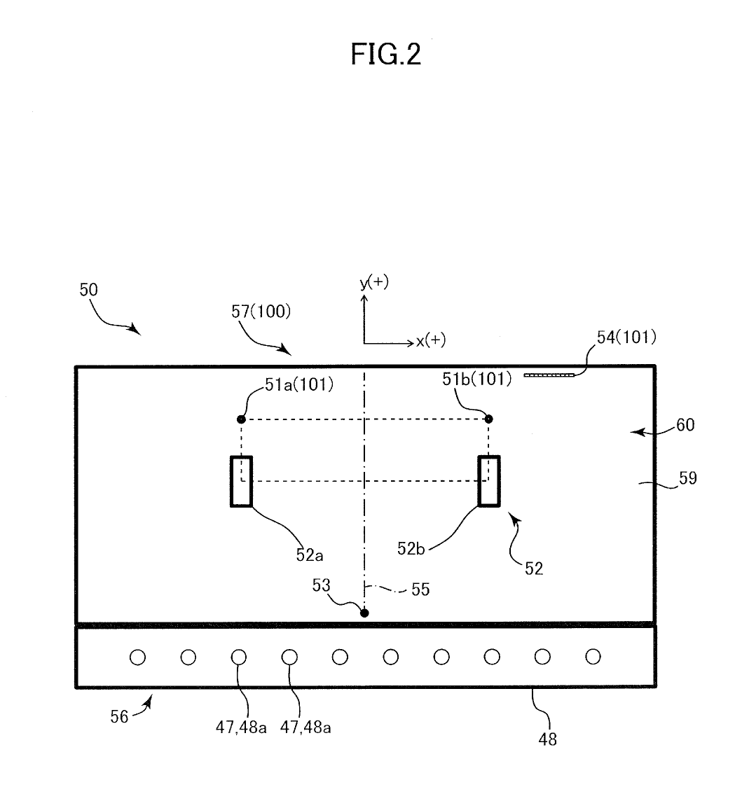

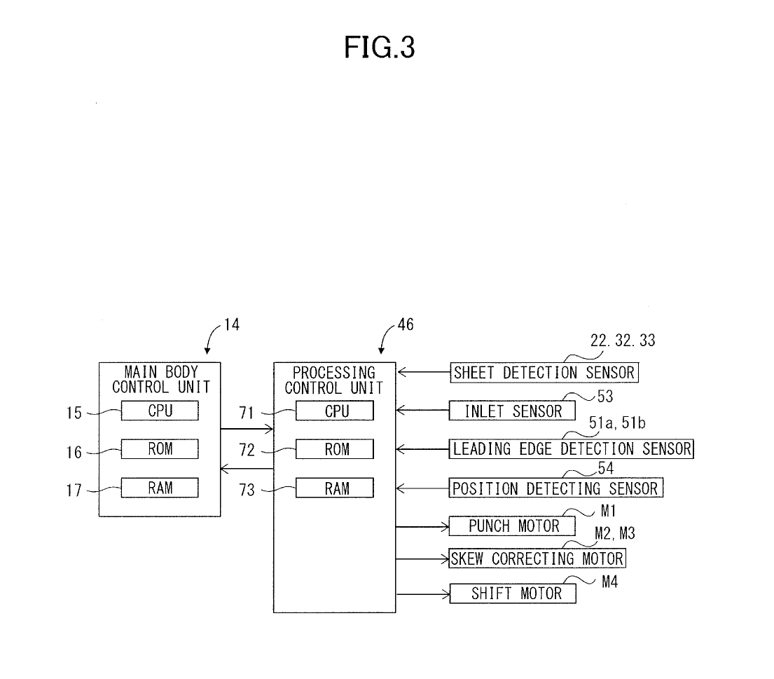

Next, we will describe the punching apparatus 50 in detail. The punching apparatus 50 includes, as illustrated in FIG. 2, a punching unit 56, and a sheet position correction unit 57. The punching unit 56 is equipped with a plurality of punches 47 that are pressed by a cam not shown driven by a punch motor M1 (refer to FIG. 3) and moved in reciprocating motion, and a fixed blade guide 48 opposed to the plurality of punches 47. The fixed blade guide 48 has a plurality of die holes 48a corresponding to the plurality of punches 47 formed thereto, and holes are punched to the sheet P by punches 47 being inserted to the die holes 48a.

The sheet position correction unit 57 is equipped with skew correcting rollers 52a and 52b arranged side by side in a width direction, that is, direction x in the drawing, orthogonal to the sheet conveyance direction, that is, direction y in the drawing, an inlet sensor 53, leading edge detection sensors 51a and 51b, and a position detecting sensor 54. The skew correcting rollers 52a and 52b serving as first and second conveyance portions constitute a skew correcting portion 52. The skew correcting rollers 52a and 52b are respectively composed of a pair of rollers, but in the following description, they are each simply referred to as skew correcting rollers. The inlet sensor 53, the leading edge detection sensors 51a and 51b and the position detecting sensor 54 are provided on a guide 59 constituting a conveyance path 60 of the sheet, and the inlet sensor 53 detects entry of the sheet P to the sheet position correction unit 57. The leading edge detection sensors 51a and 51b respectively detect the leading edge of the sheet P being conveyed, and the position detecting sensor 54 detects the side edge portion of the sheet P in the width direction.

The inlet sensor 53, the leading edge detection sensors 51a and 51b and the position detecting sensor 54 are respectively composed of photosensors, for example, and the position detecting sensor 54 is a line sensor in which a plurality of photodetectors are aligned in the width direction. The leading edge detection sensors 51a and 51b serving as first and second position detection units and the position detecting sensor 54 serving as the edge portion detection unit constitute a detection unit 101.

The skew correcting rollers 52a and 52b and the leading edge detection sensors 51a and 51b are arranged symmetrically with respect to a center line 55 in the width direction of the conveyance path 60, and the inlet sensor is arranged on the center line 55. The position detecting sensor 54 is arranged downstream of the leading edge detection sensors 51a and 51b in the sheet conveyance direction, and on one side of the center line 55. In the present embodiment, the position detecting sensor 54 is arranged on an outer side in the width direction of the leading edge detection sensor 51b serving as the second position detection unit, but it can also be arranged on an outer side in the width direction of the leading edge detection sensor 51a serving as the first position detection unit. The respective skew correcting rollers 52a and 52b can be driven independently by skew correcting motors M2 and M3 (refer to FIG. 3). The skew correcting rollers 52a and 52b can also be driven by a single skew correcting motor and a speed change mechanism such that the sheet conveyance speeds of the respective rollers can be varied independently.

Further, the skew correcting rollers 52a and 52b are supported rotatably by a holder not shown, and the holder is supported movably in the width direction. By moving the holder in the width direction by a rack and pinion and a shift motor M4 (refer to FIG. 3), the skew correcting rollers 52a and 52b are moved together with the holder in the width direction. Instead of moving only the skew correcting rollers 52a and 52b, the whole sheet position correction unit 57 can be configured to move in the width direction. The skew correcting rollers 52a and 52b are not restricted to move only in the width direction orthogonal to the sheet conveyance direction, and they should be configured movably in a direction crossing the sheet conveyance direction, such as in a direction inclined not greater than plus or minus 10 degrees with respect to the width direction.

### Configuration of Control Unit

FIG. 3 is a control block diagram of the main body control unit 14 and a processing control unit 46. The main body control unit 14 comprises, as illustrated in FIG. 3, a CPU 15, a ROM 16 storing programs for controlling various units, and a RAM 17 storing data temporarily. Various sensors and motors provided on the printer 2 are connected to the main body control unit 14.

The processing control unit 46 serving as a control unit is connected to the main body control unit 14, and includes a CPU 71, a ROM 72 storing programs for controlling various units, and a RAM 73 storing data temporarily. Sheet detection sensors 22, 32 and 33, the inlet sensor 53, leading edge detection sensors 51a and 51b, the position detecting sensor 54, the punch motor M1, skew correcting motors M2 and M3, and the shift motor M4 serving as a moving unit are connected to the processing control unit 46. In the present embodiment, various units of the punching apparatus 50 are controlled by the processing control unit 46, but the punching apparatus 50 can also be controlled by the main body control unit 14.

### Correction of Position of Sheet

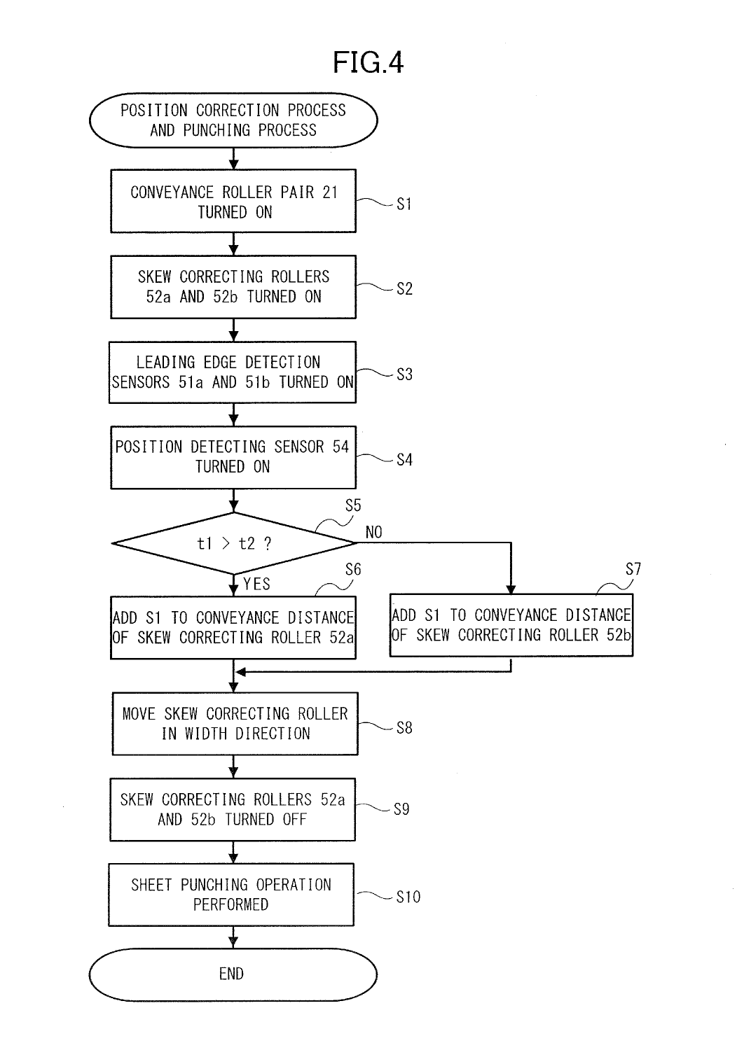

Next, a correction of position of sheets by the sheet position correction unit 57 of the punching apparatus 50 will be described with reference to FIGS. 4 through 6. FIG. 4 is a flowchart illustrating a position correction process and a punching process of the sheet. At first, in a state where the sheet detection sensor 22 detects a sheet, the processing control unit 46 drives a motor not shown and the skew correcting motors M2 and M3, to drive the conveyance roller pair 21 and the skew correcting rollers 52a and 52b (steps S1 and S2).

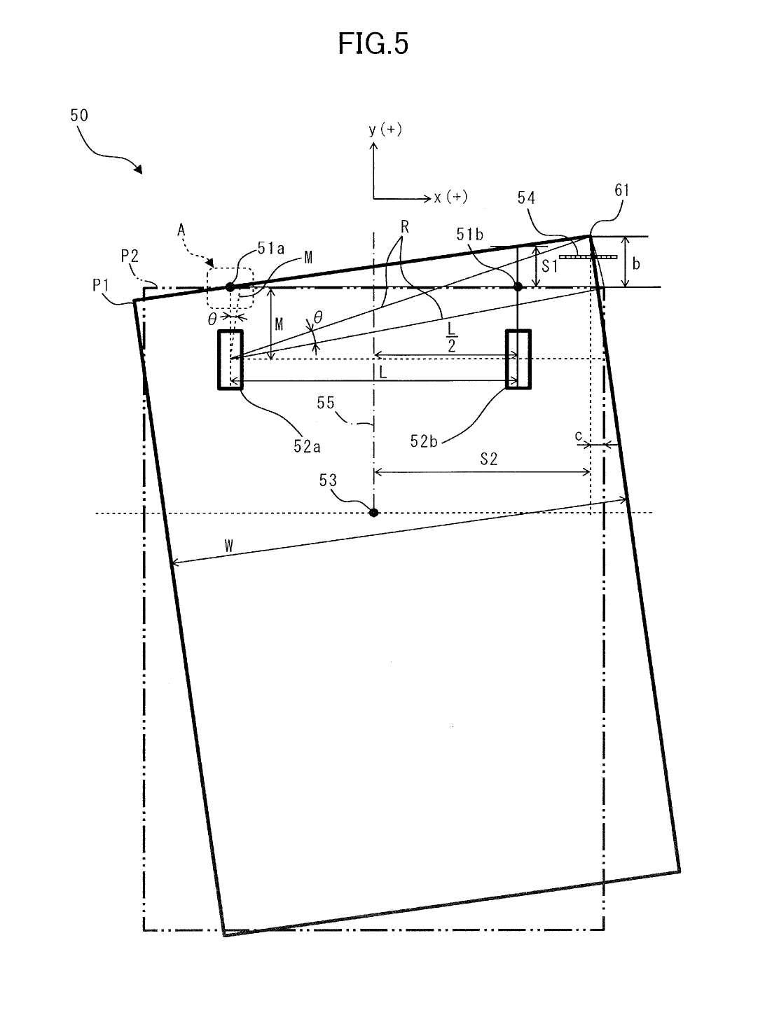

Then, in a state where the sheet P is conveyed by the conveyance roller pair 21 to the punching apparatus 50, at first, the inlet sensor 53 of the punching apparatus 50 detects passing of the sheet P, and then, the sheet P is nipped by the skew correcting rollers 52a and 52b. At this time, as illustrated in FIG. 5, the sheet P is in a skewed state P1 in which the sheet is skewed, or inclined, with respect to the sheet conveyance direction, and the skew correcting rollers 52a and 52b are rotated at a same speed. The sheet P is skewed due for example to the difference of conveyance resistance in the width direction of the conveyance path, wear of conveyance rollers, and alignment failure within the cassette.

In the following description, with the center line 55 in FIG. 5 set as reference, the side in which the position detecting sensor 54 is arranged in the width direction is referred to as a plus side of direction x, and the opposite side is referred to as a minus side of direction x. That is, the sheet in the skewed state P1 has a leading edge of the sheet in the plus side of direction x advanced than the leading edge of the sheet in the minus side of direction x. The sheet in the skewed state P1 conveyed by the skew correcting rollers 52a and 52b has the leading edge in the plus side of direction x detected by the leading edge detection sensor 51b before having the leading edge in the minus side of direction x detected by the leading edge detection sensor 51a (step S3).

Now, it becomes possible to acquire time t1 and time t2 that indicate time from when the inlet sensor 53 detects the leading edge of the sheet P and is turned on to when each of the leading edge detection sensors 51a and 51b are turned on. Based on the times t1 and t2 and the known conveyance speed of sheets of the skew correcting rollers 52a and 52b, the processing control unit 46 can measure an amount of skewing of a sheet S1. Otherwise, the amount of skewing of a sheet S1 can be measured based on a time from when either one of the leading edge detection sensors 51a and 51b has detected the sheet P to when both the leading edge detection sensors 51a and 51b have detected the sheet P (t2-t1), and the conveyance speed of the sheet. The amount of skewing of a sheet S1 refers to a difference of position of the leading edges of the sheet in the sheet conveyance direction at the positions of the leading edge detection sensor 51a and the leading edge detection sensor 51b, which approximately represents inclination of the sheet.

A distance between the leading edge detection sensors 51a and 51b and between the skew correcting rollers 52a and 52b in the width direction is referred to as L, and a distance between the leading edge detection sensors 51a and 51b and the skew correcting rollers 52a and 52b in the sheet conveyance direction is referred to as M. In the skew correcting rollers 52a and 52b, a center point in the sheet conveyance direction and the width direction is set as the start of the distance.

Thereafter, in a state where the sheet is conveyed further by the skew correcting rollers 52a and 52b, the position of the edge portion of the sheet in the width direction is detected by the position detecting sensor 54 (step S4). In the present embodiment, the position detecting sensor 54 detects the position of a corner portion 61 most downstream of the sheet in the sheet conveyance direction. That is, the processing control unit 46 can measure a distance S2 in the width direction from the center line 55 to the corner portion 61.

Next, the processing control unit 46 performs correction of position of a sheet based on the amount of skewing of a sheet S1 and the distance S2 being measured. Skewing of the sheet P can be corrected by increasing the conveyance distance of the skew correcting roller 52a corresponding to the amount of skewing of a sheet S1 than the skew correcting roller 52b before the sheet P reaches and stops at a punching position where the sheet P is punched by the punching unit 56. However, by the skew correction operation, if the sheet P is rotated in a state centered around the skew correcting roller 52a, the sheet P will be deviated by an amount of deviation c serving as a first distance in the width direction. Therefore, if the length of the sheet in the width direction is referred to as W, an amount of correction of position of a sheet in the width direction will be (S2+c−W/2), instead of (S2−W/2).

Hitherto, the sheet had been deviated corresponding to amount of deviation c in the width direction by the skew correction operation, and the amount of deviation of position in the width direction was measured for the first time after the skew correction operation had been completed, based on which the correction of position in the width direction was performed. In that case, the skew correction operation and the position correction operation in the width direction are performed serially in time series. Therefore, a longer time was required to complete all steps of sheet position correction, which caused deterioration of productivity. According to the present embodiment, the amount of deviation c by skew correction operation is computed in a geometrical manner based on distances L and M which are design values and the amount of skewing of a sheet S1 and the distance S2 which are measured values, and taking the value into consideration as a width direction correction value, by which the skew correction operation and the correction of position in the width direction can be performed approximately simultaneously.

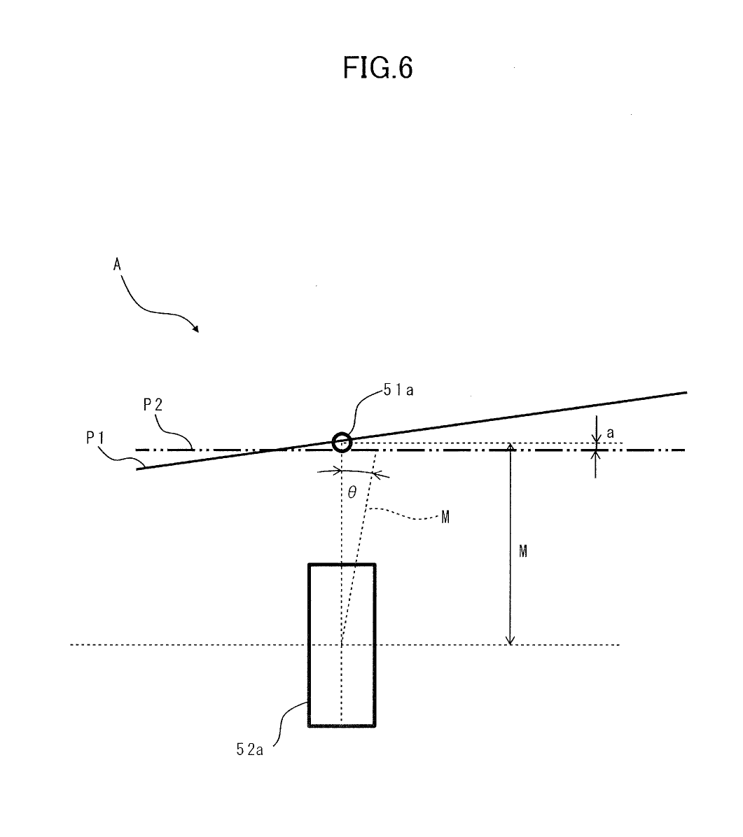

Now, the actual method will be described. At first, the necessary length and angle for acquiring the amount of deviation c in a geometrical manner are determined as illustrated in FIGS. 5 and 6. That is, a radius of locus of the corner portion 61 in a state where the sheet P rotates around the skew correcting roller 52a is denoted as R, a pivoting angle of a state where the sheet P is subjected to skew correction is denoted as θ, and a distance in the sheet conveyance direction that the corner portion 61 moves by skew correction is denoted as b. An enlarged view of area A illustrated by the dotted line of FIG. 5 is illustrated in FIG. 6. The distance in which the leading edge of the sheet moves in the sheet conveyance direction while the sheet P moves from the skewed state P1 to a corrected state P2 where skewing is corrected is denoted as distance a. The amount of deviation c can be expressed by following relational expressions which are defined by a geometrical relationship and a trigonometric function and expressed by using L, M, R, θ, b as design values, and the amount of skewing of a sheet S1 and the distance S2 as measured values as follows.

$$\begin{matrix}{( \frac{L}{2} + S 2 )}^{2} + {( b + M - a )}^{2} = {R}^{2} & ( 1 ) \\ {( \frac{L}{2} + S 2 + c )}^{2} + {( M - a )}^{2} = {R}^{2} & ( 2 ) \\ tan θ = \frac{S 1}{L} = \frac{b - a}{\frac{L}{2} + S 2} & ( 3 ) \\ cos θ = \frac{M - a}{M} & ( 4 ) \\ {( cos θ )}^{2} = \frac{1}{1 + {( tan θ )}^{2}} & ( 5 )\end{matrix}$$

Based on the above expressions (1) through (5), the following expression expresses the amount of deviation c using only the distances L and M, the amount of skewing of a sheet S1 and the distance S2.

$$c = \sqrt{{( \frac{L}{2} + S 2 )}^{2} + {\{ \frac{S 1}{L} ( \frac{L}{2} + S 2 ) + M \}}^{2} - \frac{{L}^{2} {M}^{2}}{{L}^{2} + S {1}^{2}}} - ( \frac{L}{2} + S 2 )$$

Thereby, if the amount of skewing of a sheet S1 and the distance S2 can be measured, an amount of correction of position (S2+c−W/2) as a second distance can be acquired, which is the moving amount of the sheet to a reference position in the width direction of the sheet. Now, returning to FIG. 4, if it is determined that the position detecting sensor 54 is turned on, the processing control unit 46 determines whether the above-described time t1 is greater than time t2 (step S5). If time t1 is greater than time t2 (step S5: YES), the processing control unit 46 sets the conveyance distance of the sheet by the skew correcting roller 52a to be greater by the amount of skewing of a sheet S1 than the conveyance distance of the skew correcting roller 52b (step S6).

If time t1 is smaller than time t2 (step S5:NO), the processing control unit 46 sets the conveyance distance of the sheet by the skew correcting roller 52b to be greater by the amount of skewing of the sheet S1 than the conveyance distance of the skew correcting roller 52a (step S7).

Then, the processing control unit 46 drives the shift motor M4 such that the skew correcting rollers 52a and 52b are moved in the width direction corresponding to the amount of correction of position (S2+c−W/2) (step S8). The computing of the amount of correction of position (S2+c−W/2) by the processing control unit 46 is performed during the time from when the position detecting sensor 54 is turned on to when the shift motor M4 is driven. Between steps S4 to S9, at least a portion of the skew correction operation of the sheet performed based on the difference in the conveyance distances of the sheet by the skew correcting rollers 52a and 52b is performed simultaneously as step S8. Then, the skew correcting rollers 52a and 52b do not stop during skew correction operation. That is, the processing control unit 46 performs control such that the skew correction of the sheet by the skew correcting rollers 52a and 52b and the movement of the skew correcting rollers 52a and 52b by the shift motor M4 are performed in parallel. In other words, the skew correction of the sheet by the skew correcting rollers 52a and 52b and the movement of the skew correcting rollers 52a and 52b by the shift motor M4 are performed at the same time. According to the present embodiment, the drive of the shift motor M4 is started while the skew correcting rollers 52a and 52b are driven, and the driving of the shift motor M4 is ended while the skew correcting rollers 52a and 52b are driven.

In step S8, if the sheet P is moved only in correspondence with the amount of correction of position (S2+c−W/2), the processing control unit 46 stops the shift motor M4, and further, if the sheet P is positioned at the punching position, the skew correcting rollers 52a and 52b are stopped (step S9). Then, the processing control unit 46 drives the punch motor M1 so that the plurality of punches 47 are inserted to the plurality of die holes 48a, and holes are punched to the sheet P (step S10).

As described, according to the present embodiment, the amount of deviation c caused by performing skew correction of a sheet by the skew correcting rollers 52a and 52b is computed before driving the shift motor M4, and in parallel with the skew correction operation, the shift motor M4 is driven corresponding to the amount of correction of position in which the amount of deviation c has been added. Therefore, the time required to perform correction of position of the sheet can be shortened while ensuring accuracy of correction of sheet position, especially the position correction accuracy in the width direction, and the productivity can be enhanced.

In the present embodiment, the skew correcting rollers 52a and 53b and the leading edge detection sensors 51a and 51b are arranged at the same positions in the width direction, but they can also be arranged in different positions. In that case, it is necessary to acquire the distance between the leading edge detection sensors 51a and 51b by adding a value that differs from the distance L as design value to the aforementioned geometrically-acquired expression. The position of the position detecting sensor 54 in the width direction is not especially restricted, but the closer the position of the position detecting sensor 54 is to the leading edge detection sensors 51a and 52b, the shorter the required time becomes to detect the sheet position, and therefore, higher productivity can be expected.

According to the present embodiment, the amount of skewing of a sheet S1, the distance S2 and the amount of deviation c have been computed based on the operation of the CPU 71 based on the detection results of the leading edge detection sensors 51a and 51b and the position detecting sensor 54, but the method is not restricted thereto. A table information in which the detection results of the leading edge detection sensors 51a and 51b and the position detecting sensor 54 are associated with the amount of skewing of a sheet S1, the distance S2 and the amount of deviation c may be stored in advance to the ROM 72 or the RAM 73 serving as the storage unit. The amount of correction of position of the sheet P in the width direction may be acquired based on this table information.

### Second Embodiment

Next, a second embodiment of the present invention will be described. Since only the position correction process of the first embodiment is changed according to the second embodiment, that configurations similar to the first embodiment are either not shown in the drawings, or denoted with the same reference numbers in the drawings.

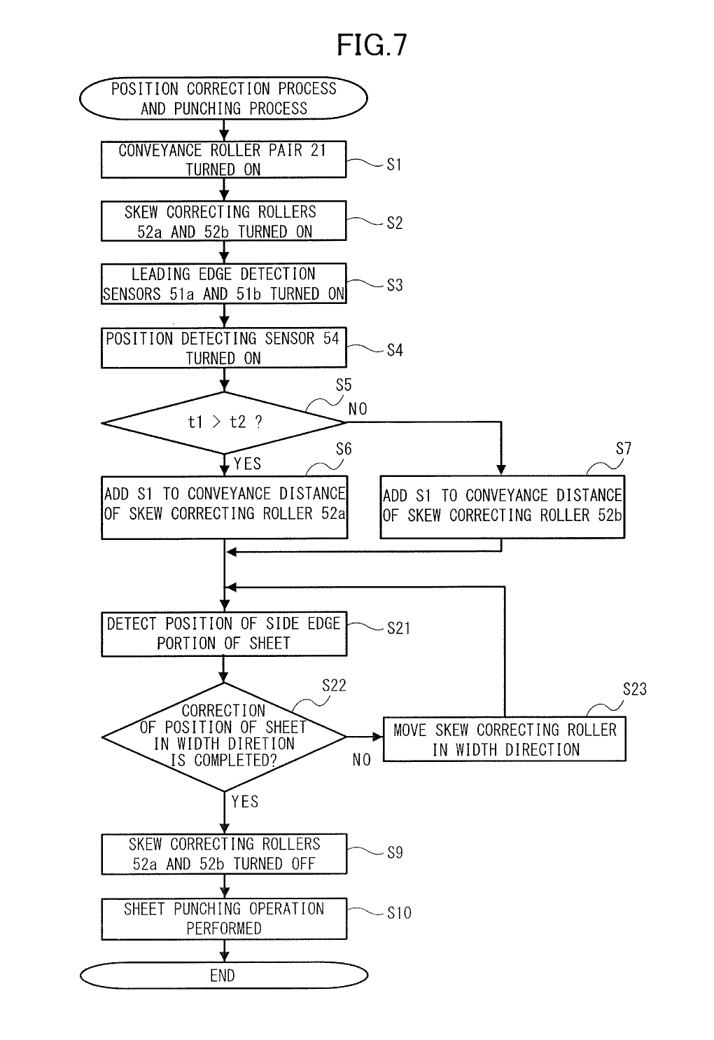

FIG. 7 is a flowchart of a position correction process and a punching process according to the second embodiment. Steps S1 through S7 and steps S9 and S10 are similar to the first embodiment, so that descriptions thereof are omitted. In step S21, the processing control unit 46 detects a position of the side edge portion of the sheet P in the width direction by the position detecting sensor 54. In the first embodiment, the position detecting sensor 54 only detects the corner portion 61 of the sheet P, but in the present embodiment, the side edge portion of the sheet is successively detected in addition to the corner portion 61.

Then, based on the detection result of the position detecting sensor 54, the processing control unit 46 determines whether correction of position of the sheet P in the width direction has been completed, that is, whether a center of the sheet P in the width direction and the center line 55 (refer to FIG. 5) correspond (step S22). If correction of position in the width direction of the sheet P is not completed (step S22: NO), the shift motor M4 is driven based on the detection result of the position detecting sensor 54, and the skew correcting rollers 52a and 52b are moved in the width direction together with the sheet (step S23).

Then, after returning to step S21, feedback control is performed in which steps S21 through S23 are repeated. That is, the processing control unit 46 drives the shift motor M4 such that the correction of position of the sheet P is completed based on the position of the sheet in the width direction successively detected by the position detecting sensor 54. According to step S22, if correction of position of the sheet P in the width direction is completed (step S22: YES), the procedure advances to step S9. Also according to the present embodiment, the position correction operation in the width direction of steps S21 through S23 is performed in parallel with the skew correction operation by the skew correcting rollers 52a and 52b.

As described, according to the present embodiment, the position of the sheet P is successively detected by the position detecting sensor 54, and position correction operation of the sheet P in the width direction is performed by feedback control. Therefore, even if the sheet P is deviated in the width direction during skew correction operation by the skew correcting rollers 52a and 52b, correction of position of the sheet P can be performed highly accurately. Further, the skew correction operation and the position correction operation in the width direction are performed in parallel, such that the time required to correct the position of a sheet can be shortened, and productivity can be improved.

According to the first and second embodiments, a sheet position correction device 100 (refer to FIGS. 1 and 2) is configured of the processing control unit 46 and the sheet position correction unit 57. However, the sheet position correction device can include the punching unit 56 serving as a processing unit and a punching unit configured to execute processes to the sheets, or the finisher 3 can be the sheet position correction device. Further, an example has been illustrated of a case where the correction of position of a sheet is performed by the skew correcting rollers 52a and 52b prior to punching holes to the sheet P, but the present invention is not restricted to this example. The present invention can also be applied to a finisher having a streaking device, instead of the punching unit 56, by which streaking is provided to sheets, and performing correction of position of a sheet by the skew correcting rollers 52a and 52b prior to streaking the sheets.

Further, for example, the present invention can be applied to a device performing correction of position of a sheet prior to forming images on the sheet by the image forming unit 7, or in another example, the printer body 4 and the image forming system 1 can serve as the sheet position correction device.

According to the first and second embodiments described above, the leading edge detection sensors 51a and 51b and the position detecting sensor 54 that are configured to detect sheets one-dimensionally are adopted, but the present invention is not restricted to this example. For example, the present invention can adopt an area sensor configured to detect inclination and position in the width direction of the sheet two-dimensionally.

In any of the above-described embodiments, the printer 2 adopting an electrophotographic system has been described for description, but the present invention is not restricted to this example. For example, the present invention can be applied to an image forming apparatus adopting an ink-jet system configured to form images on sheets by discharging liquid ink through nozzles.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-209781, filed Oct. 26, 2016, which is hereby incorporated by reference wherein in its entirety.

What is claimed is:

1. A sheet position correction device comprising:
a detection unit configured to detect inclination of a sheet, and a position of a sheet in a width direction orthogonal to a sheet conveyance direction;
a skew correcting portion comprising first and second conveyance portions arranged in the width direction, the skew correcting portion being configured to convey the sheet, and correct skewing of the sheet by a difference between a conveyance distance of the sheet by the first conveyance portion and a conveyance distance of the sheet by the second conveyance portion;
a moving unit configured to move the skew correcting portion in the width direction; and
a control unit configured to perform control such that skew correction of the sheet by the skew correcting portion and movement of the skew correcting portion by the moving unit are performed in parallel based on a detection result of the detection unit.

2. The sheet position correction device according to claim 1, wherein the control unit is configured to control the skew correcting portion based on inclination of the sheet detected by the detection unit, and control the moving unit such that the skew correcting portion is moved for a second distance computed based on a first distance that the sheet moves in the width direction if skewing of the sheet is corrected by the skew correcting portion, and a position of the sheet in the width direction detected by the detection unit.

3. The sheet position correction device according to claim 2, wherein the control unit computes the first distance and the second distance based on the detection result of the detection unit.

4. The sheet position correction device according to claim 2, wherein the control unit comprises a storage unit storing information having associated a detection result of the detection unit with the first distance, and computes the second distance based on the information.

5. The sheet position correction device according to claim 1, wherein the control unit performs feedback control of the moving unit based on a position of the sheet in the width direction detected by the detection unit.

6. The sheet position correction device according to claim 1, wherein the detection unit comprises first and second position detection units which are arranged in the width direction and configured to detect a position of the sheet in the sheet conveyance direction, and an edge portion detection unit configured to detect a position of an edge portion of the sheet in the width direction, and
the control unit computes inclination of the sheet based on a time from when either the first position detection unit or the second position detection unit detects the sheet to when both the first position detection unit and the second position detection unit detect the sheet, and a conveyance speed of the sheet.

7. The sheet position correction device according to claim 6, wherein the edge portion detection unit is arranged downstream in the sheet conveyance direction of the first and second position detection units, and arranged outward in the width direction than the first and second position detection units.

8. The sheet position correction device according to claim 6, wherein the edge portion detection unit detects a position of a corner portion of the sheet in a most downstream portion in the sheet conveyance direction.

9. The sheet position correction device according to claim 1, wherein the control unit starts driving the moving unit in a state where the first and second conveyance portions are driven.

10. The sheet position correction device according to claim 1, wherein the control unit stops driving of the moving unit in a state where the first and second conveyance portions are driven.

11. The sheet position correction device according to claim 1, wherein the sheet position correction device comprises a processing unit configured to execute processing to the sheet.

12. The sheet position correction device according to claim 11, wherein the processing unit comprises a punching unit configured to punch the sheet.

13. The sheet position correction device according to claim 1, further comprises an image forming unit configured to form an image on the sheet.
